(19) United States
(12) Patent Application Publication
(10) Pub. No.: US 2007/0002684 A1
(43) Pub. Date: Jan. 4, 2007

(54) MEANS FOR CONNECTING DRIVING SHAFT AND MIXING PADDLE OF A MIXER

(75) Inventor: Youjun Dai, Nanjing (CN)

Correspondence Address: WALLENSTEIN & WAGNER, LTD., 311 SOUTH WACKER DRIVE, 53RD FLOOR, CHICAGO, IL, 60606, US

(73) Assignee: NANJING CHERVON INDUSTRY CO., LTD., Nanjing (CN)

(21) Appl. No.: 11/427,286

(22) Filed: Jun. 28, 2006

(30) Foreign Application Priority Data
Jun. 30, 2005 (CN) 200520073175.1

(51) Int. Cl. B01F 7/00

(52) U.S. Cl. 366/279

(57) ABSTRACT

A means for connecting a driving shaft and a mixing paddle of a mixer including a driving shaft, a spindle of the mixing paddle and a clamping means, in which the clamping means comprises a clamping member and a locking member. The clamping member comprises a chamber for receiving the spindle of the mixing paddle, and at least one oblique surface extending along the direction of the spindle. The locking member engages between the oblique surface and the spindle. The clamping means further includes a rotation restricting means for restricting the relative rotation between the spindle and the driving shaft. With this structure, the connecting means is simple, reliable and can be easily operated without auxiliary tools. In fact, an operator may remove and attach the mixing paddle to the driving shaft without auxiliary tools.

### CROSS-REFERENCE TO RELATED APPLICATIONS

This application claims priority to Chinese Application No. 200520073175.1, filed on Jun. 30, 2005, the entire disclosure of which is incorporated herein by reference. Priority to this application is claimed under 35 U.S.C. 119, 120 and/or 365.

### TECHNICAL FIELD

The present invention relates to a means for connecting driving shaft and mixing paddle of a mixer.

### BACKGROUND OF THE INVENTION

A mixer commonly includes a mixing paddle which can be extended into a barrel to mix uniformly the material to be mixed, such as mortar. A driving system, which is connected to a fixing frame, is positioned above the barrel to rotate the mixing paddle. The driving system is generally formed with a driving shaft that is powered by an electric, pneumatic or hydraulic motor. A spindle of the mixing paddle is connected to the driving shaft.

When the mixing operation is finished, the mixing paddle must be moved away from the barrel to pour out the mixed material. Since the fixing frame has a predetermined height, it is difficult to move away the mixing paddle together with the driving system. Normally, it has to disengage the mixing paddle from the driving shaft and then move away from the barrel. When mixing powder mass, a cover shall be disposed on the barrel with the spindle of the mixing paddle extending through the cover. In this case, it is necessary to disengage the mixing paddle from the driving shaft. Moreover, the disengagement action occurs in many other conditions, such as cleaning, replacing the mixing paddle, etc. The operation for attaching or removing the mixing paddle to or from the driving shaft is so frequent that a connecting means, which can carry out the aforementioned operation quickly and easily is highly desired.

The conventional connecting means is provided with threaded engagement which must be operated with a tool, such as a wrench. Since the mixer is usually used in the condition with powder, the threaded engagement is often prone to be blocked, and thus can not be loosened.

The present invention is provided to solve the problems discussed above and other problems, and to provide advantages and aspects not provided by prior mixers of this type. A full discussion of the features and advantages of the present invention is deferred to the following detailed description, which proceeds with reference to the accompanying drawings.

### SUMMARY OF THE INVENTION

The purpose of the present invention is to provide a means for connecting a driving shaft and a mixing paddle of a mixer. The connection means has a simple structure, which can be easily operated and will not be blocked or compromised by the material to be mixed.

For achieving the above-mentioned purpose, a means for connecting a driving shaft and a mixing paddle of a mixer according to the present invention includes a driving shaft, a spindle of the mixing paddle and a clamping means, in which the clamping means comprises a clamping member and a locking member. The clamping member comprises a chamber for receiving the spindle of the mixing paddle and at least one oblique surface extending along the direction of the spindle. The locking member includes a substantially circular cross-section and is engaged between the oblique surface and the spindle. The clamping means further includes a spring means to make the locking member tend to move towards the spindle along the oblique surface, and a rotation restricting means for restricting the relative rotation between the spindle and the driving shaft.

In the present invention, the connecting means does not adopt a threaded engagement, but in a manner of engagement between the locking member and the oblique surface, and providing a rotation restricting means for clamping the spindle of the mixing paddle. With this structure, the operator can remove and attach the mixing paddle without any auxiliary tools since the connecting means is simple and reliable.

### BRIEF DESCRIPTION OF THE DRAWINGS

The preferred embodiments of the present invention will be described in detail with reference to the attached drawings.

FIG. 1 is a schematic view showing the whole mixer.

FIG. 2 is an exploded perspective view showing one embodiment of the means for connecting driving shaft and mixing paddle according to the present invention.

FIG. 3 is a partial sectional view of the means for connecting the driving shaft and the mixing paddle of the mixer shown in FIG. 2.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

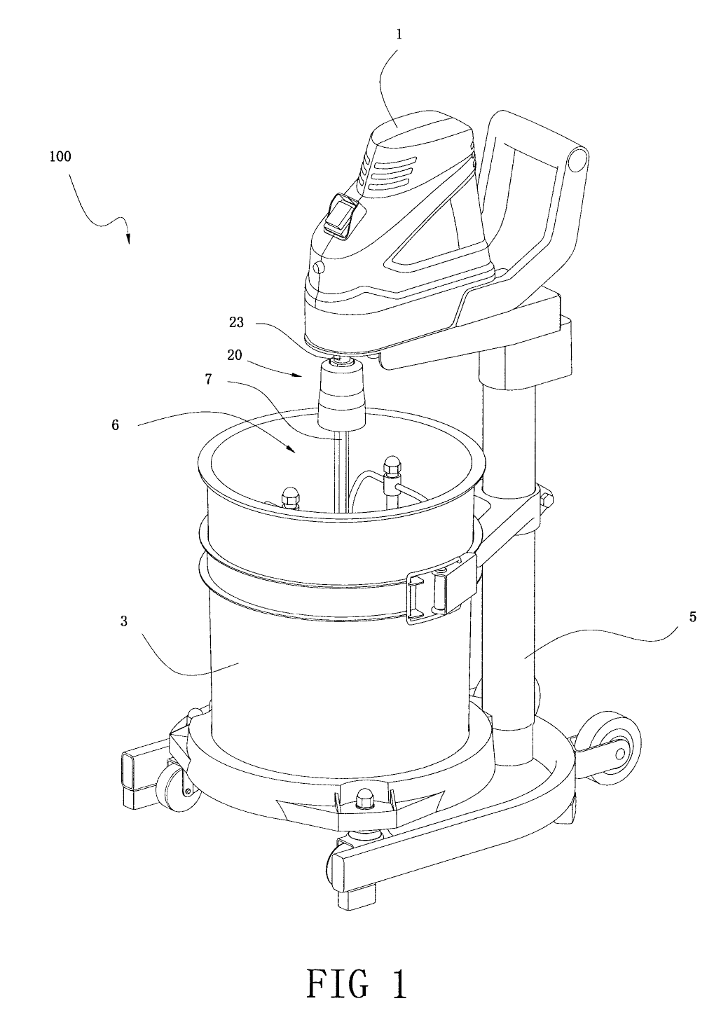

Referring to FIG. 1, a mixer 100 commonly includes a mixing paddle 6 which can be extended into a barrel 3 to uniformly mix the material, such as mortar. A driving system 1, which is connected to a fixing frame 5, is positioned above the barrel 3 to rotate the mixing paddle 6. The driving system 1 generally comprises a motor (not shown) and a driving shaft 23 to be driven by the motor. The mixing paddle 6 includes a spindle 7 which is connected to the driving shaft 23 by means of a clamping means 20.

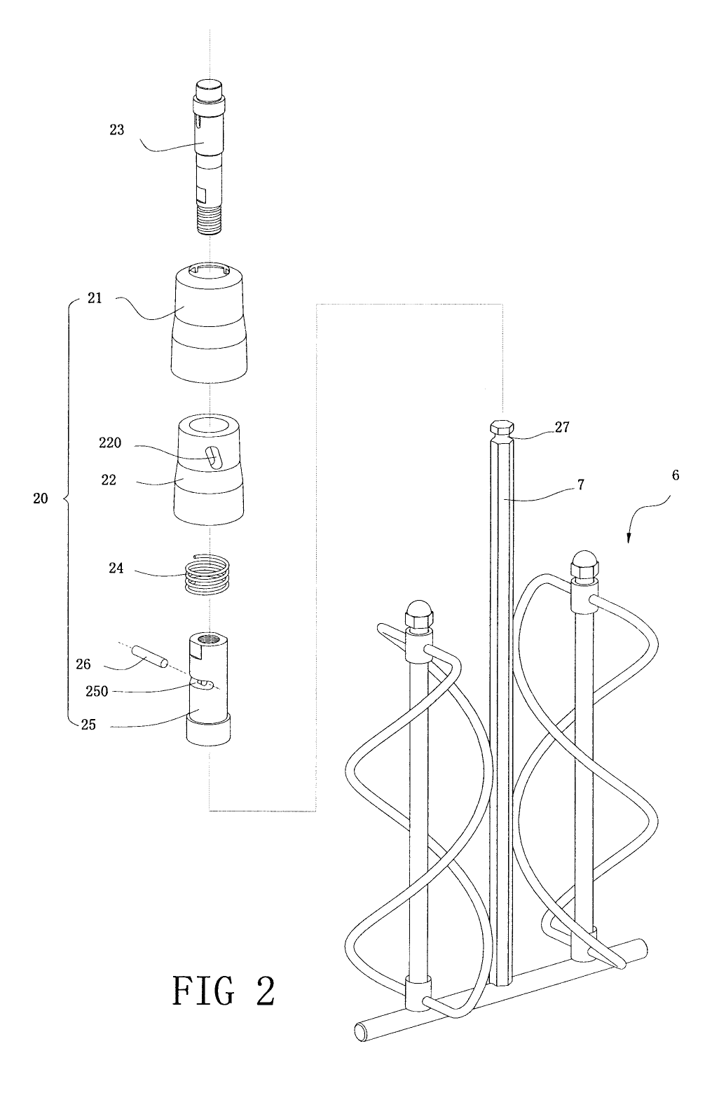

A preferred embodiment of the present invention is shown in FIG. 2, in which the clamping means 20 includes a sleeve 21, a clamping member 22, a spring 24, a fixing member 25 and a locking member 26. The clamping member 22 defines an oblique slot 220 tilted relative to a perpendicular direction. The fixing member 25 is formed with a hollow cylinder comprising an inner chamber 251 for receiving the spindle 7 of the mixing paddle 6. The fixing member 25 comprises a transverse groove 250 on one of its side walls. The groove 250 communicates with the inner chamber 251.

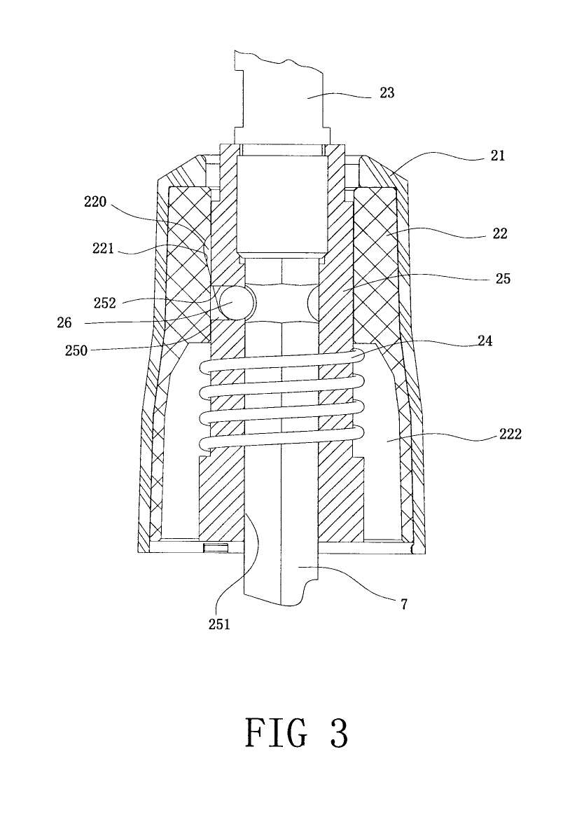

Referring to FIGS. 2 and 3, the lower portion of the driving shaft 23 extends into the fixing member 25 to fixedly connect with the upper portion of the fixing member 25 by means of threaded engagement. In the shown embodiment, the spindle 7 of the mixing paddle 6 with a hexagonal cross-section is provided with a positioning device 27 on the top thereof which is a circumferential slot in the embodiment. The lower portion of the driving shaft 23 includes a hollow chamber 230 which has a hexagonal cross-section with a size for the top portion of the spindle 7 of the mixing paddle 6 extending therein. The hollow chamber 230 and the spindle 7 of the mixing paddle 6, which will not be limited to the above-mentioned shapes, can be other appropriate shapes except the cylindrical. With the non-circular engagement between the hollow chamber 230 and the spindle 7, the relative rotation between the driving shaft 23 and the spindle 7 of the mixing paddle 6 is effectively avoided.

As shown in FIG. 3, where the spindle 7 of the mixing paddle 6 extends into the hollow chamber 230 and contacts the bottom thereof, the positioning device 27 is just aligned with the groove 250. The clamping member 22 is provided around the fixing member 25. The locking member 26 extends through the slot 220 and the groove 250. The spring 24, which is positioned in a chamber 222 of the clamping member 22, biases between the fixing member 25 and the clamping member 22 and is compressed in this case. The bias force produced by the spring 24, which is applied to the clamping member 22, makes the locking member 26 tend to move upwardly (in the direction of the bias force). Furthermore, with the restriction of an upper side-wall 252 of the groove 250 and an oblique surface 221 of the oblique slot 220, the locking member 26 is restricted in the lower portion of the oblique slot 220, that is, deeply received in the positioning device 27 of the spindle 7 so that the upward and downward movement of the spindle 7 is effectively prevented.

The relative position between the fixing member 25 and the clamping member 22 is not limited to the above-mentioned manner. The fixing member 25 also can be provided outside of the clamping member 22, but at least partial portion of the locking member 26 is engaged with the upper side-wall 252.

A sleeve 21 is positioned outside of the clamping member 22 to prevent the locking member 26 from transversely sliding out and preventing dust from entering into the inside of the clamping means 20.

To remove the mixing paddle 6 from the mixer 100, the sleeve 21 is pushed downwardly to move the clamping member 22 so that the locking member 26 is moved towards the upper portion of the oblique slot 220 and disengaged from the positioning device 27 along the upper side-wall 252 in a radial direction. The spindle 7 of the mixing paddle 6 then is disengaged from the hollow chamber 230 of the driving shaft 23.

To attach the mixing paddle 6, the sleeve 21 is pushed downwardly and then released until the spindle 7 is extended into the hollow chamber 230 of the driving shaft 23. The clamping member 22 is restored with the function of the spring 24, and then the locking member 26 is engaged with the positioning device 27 to achieve the axial fixation.

The means for connecting the driving shaft and the mixing paddle of the mixer disclosed in the present invention is not limited to the preferred embodiments as described and shown in the drawings. The characterizing feature of the present invention is the clamping device, which utilizes an oblique slot and the cylindrical locking member to clamp the spindle of the mixing paddle. According to this feature, the particular shape and position of the other parts may be modified and still fall within the protective scope of the present invention.

While the specific embodiments have been illustrated and described, numerous modifications come to mind without significantly departing from the spirit of the invention, and the scope of protection is only limited by the scope of the accompanying Claims.

What is claimed is:

1. A connection device for a mixer, comprising:
a driving shaft;
a mixing paddle having a spindle and a clamp, wherein the clamp comprises a locking member having a substantially circular cross-section; and,
a clamping member disposed on the mixing paddle, wherein the clamping member comprises a chamber for receiving the spindle and an oblique surface parallel to the spindle, wherein the locking member is engaged between the oblique surface and the spindle.

2. The device of claim 1, further comprising:
a spring tending to move toward the spindle along the oblique surface.

3. The device of claim 1, further comprising:
a rotation restriction member for restricting rotation between the spindle and the driving shaft.

4. The device of claim 1, wherein the spindle comprises a positioning member to be engaged with the locking member.

5. The device of claim 2, wherein the clamping member further comprises:
a positioning member having a surface substantially perpendicular to the spindle, wherein a portion of the surface is engaged with the spring.

6. The device of claim 5, wherein the spring is disposed between the positioning member and the clamping member.

7. The device of claim 3, wherein the rotation restricting member is non-circular and is disposed between the spindle and the driving shaft.

8. The device of claim 1, wherein the spindle comprises a circumferential groove perpendicular to an axis of the spindle.

9. The device of claim 1, further comprising:
a sleeve disposed on an exterior of the clamping member for preventing the clamping member from sliding.

10. A connection device for a mixer, comprising:
a spindle; and,
a clamp disposed on the spindle, wherein the clamp comprises a locking member disposed radially on an exterior of the spindle, wherein the clamp comprises a chamber for receiving the spindle and an oblique surface parallel to the spindle, wherein the locking member is engaged between the oblique surface and the spindle.

11. The device of claim 10, further comprising:
a spring tending to move toward the spindle along the oblique surface.

12. The device of claim 10, further comprising:
a rotation restriction member for restricting rotation between the spindle and a driving shaft of the mixer.

13. The device of claim 10, wherein the spindle comprises a positioning member to be engaged with the locking member.

14. The device of claim 11, wherein the clamp further comprises:
a positioning member having a surface substantially perpendicular to the spindle, wherein a portion of the surface is engaged with the spring.

15. The device of claim 14, wherein the spring is disposed between the positioning member and the clamp.

16. The device of claim 12, wherein the rotation restricting member is non-circular and is disposed between the spindle and the driving shaft.

17. The device of claim 10, wherein the spindle comprises a circumferential groove perpendicular to an axis of the spindle.

18. The device of claim 10, further comprising:
a sleeve disposed on an exterior of the clamp for preventing the clamp member from sliding.

19. The device of claim 10, further comprising:
a mixing paddle connected to the spindle.

20. A connection device for a mixer, comprising:
a spindle;
a clamp disposed on the spindle, wherein the clamp comprises a locking member disposed radially on an exterior of the spindle, wherein the clamp comprises a chamber for receiving the spindle and an oblique surface parallel to the spindle, wherein the locking member is engaged between the oblique surface and the spindle;
a sleeve disposed on an exterior of the clamp for preventing the clamp member from sliding; and,
a spring tending to move toward the spindle along the oblique surface.
